(19) United States
(12) Patent Application Publication
(10) Pub. No.: US 2015/0198242 A1
(43) Pub. Date: Jul. 16, 2015

(54) Method and Controller for a Powertrain in a Machine

(71) Applicant: Caterpillar Inc., Peoria, IL (US)

(72) Inventor: Kevin J. Knox, Peoria, IL (US)

(73) Assignee: Caterpillar Inc., Peoria, IL (US)

(21) Appl. No.: 14/152,260

(22) Filed: Jan. 10, 2014

(51) Int. Cl. F16H 61/14; F16H 59/44

(52) U.S. Cl. CPC F16H 61/14; F16H 59/44

(57) ABSTRACT

The method and controller regulate a machine having a powertrain including an engine connected to a transmission having a plurality of gear ratios for changing the speed ratio. Disposed between the engine and the transmission is a torque convertor associated with a lockup clutch. A shift signal can be received that indicates a gear shift between gear ratios. In response, the fluid pressure in the lockup clutch can be reduced to an unlocked pressure at which the lockup clutch is unlocked but does not slip. The speed ratio in the transmission is thereafter monitored for an inertia phase and a torque phase. In the inertia phase, the speed ratio of the transmission begins to change and in the torque phase, the speed ratio remains constant. During the inertia phase, the fluid pressure in the lockup clutch is reduced to a hold pressure in which the lockup clutch slips.

### TECHNICAL FIELD

This patent disclosure relates generally to a machine equipped with a powertrain and, more particularly, to methods and controls for shifting gear ratios in a transmission included in the powertrain.

### BACKGROUND

Many machines use multispeed transmissions to couple the rotational output of a prime mover or power source, such as an internal combustion engine, to a driven element or devices such as wheels, continuous tracks, or a work implement. This combination of components for transmitting power, along with possible other components and devices such as a driveshaft, differentials, and the like, is sometimes referred to as a powertrain. The transmission itself may include one or more fixed, selectably engageable gear ratios that can be used to increase or decrease the speed output of the prime mover and, usually in an inverse relationship, the torque. The selected gear ratio of the transmission can also be referred to as the speed ratio that represents the ratio of the speed of the input shaft to the output shaft of the transmission as measured, for example, in revolutions per minute. The transmission thereby provides another way of varying the speed and/or direction of the rotational output of the powertrain. When shifting from one gear ratio to another, the physical engagement and disengagement of the selected gear ratios can be accomplished by actuating one or more oncoming clutches to engage or mesh two or more gears and deactivating one or more off-going clutches to disengage two or more previously engaged gears.

When changing or shifting gear ratios, it is sometimes desirable to decouple the mechanical connection between the prime mover and the transmission to modify the motive force through the transmission and to allow the different gear ratios to synchronize during the gear shift. To accomplish such decoupling of an automatic transmission, a torque convertor can be disposed between the transmission and the prime mover. Torque convertors are typically hydrodynamic fluid couplings that provide an indirect fluid connection between a rotating input, referred to as an impeller, and a rotatable output, referred to as a turbine. The impeller imparts a rotational force to hydraulic fluid sealed inside the torque convertor that causes the turbine to spin thereby transferring rotational power. The torque convertor also allows the turbine to “slip” with respect to the impeller so that the two components move at different relative speeds. The ability of the torque convertor to accommodate slip provides the indirect coupling between the prime mover and the transmission but can also result in efficiency losses as power is dissipated as fluid friction and heat in the torque convertor.

To reduce or avoid these efficiency losses when possible, some torque convertors include a locking mechanism that forms a direct physical interconnection between the input and output to transfer the rotational power directly between the prime mover and the transmission. Such locking mechanisms are sometimes referred to as lockup clutches that can be selectively engaged when the relative speed of the impeller and turbine are close and slip in the torque convertor is undesirable. Furthermore, the torque convertor and lockup clutch can be used together to facilitate shifting of the gear ratios in the transmission and possibly to reduce jolting as the gear ratios engage. For example, U.S. Patent Application 2011/0231073 describes a system and method in which a parameter associated with the transmission is observed to determine when a gear shift occurs and to assess the progress of the gear shift process. When performing a power-on upshift of gear ratios, the measured variations in that parameter from the transmission can be used to determine when to release or engage the lockup clutch of the torque convertor. The present disclosure also addresses coordination of a multispeed transmission with a lockup clutch of a torque convertor when shifting gears.

### SUMMARY

In an aspect, the present disclosure describes a method of shifting gear ratios in a machine having a powertrain that interconnects an engine to a transmission through a torque convertor. The transmission can include a plurality of selectively engageable gear ratios for changing the speed ratio of the transmission. According to the method, a shift signal is received that directs a gear shift between gear ratios in the transmission. In response, the method adjusts the fluid pressure in a lockup clutch associated with the torque convertor to an unlocked pressure. At the unlocked pressure, the lockup clutch is physically unlocked but does not experience significant amounts of slip. Further, the method monitors a speed ratio of the transmission during the gear shift for an inertia phase and a torque phase. In the inertia phase, the speed ratio of the transmission begins to change and in the torque phase, the speed ratio remains relatively constant. Upon commencement of the inertia phase, the method reduces the fluid pressure in the lockup clutch to a hold pressure during which the lockup clutch experiences significant slip.

In another aspect, the disclosure describes a machine having an engine for generating a rotational force that is connected to a transmission that includes a plurality of selectively engageable gear ratios for changing a speed ratio of the transmission. The machine may also include a gear selector for directing a gear shift of the plurality of selectively engageable gear ratios in the transmission. To monitor the speed ratio, a sensor may be operatively associated with the transmission. Disposed between the engine and the transmission is a torque convertor operatively associated with a lockup clutch. The machine can also include a controller that communicates with the gear selector and with the transmission sensor. The controller is programmed to reduce fluid pressure in the lockup clutch during an inertia phase of the gear shift during which the speed ratio changes. The controller is further programmed to maintain fluid pressure in the lockup clutch during a torque phase during which the speed ratio is relatively constant.

In yet another aspect, the disclosure describes a method of operating a machine having a powertrain in which an engine directs rotational power to a transmission. The method involves a controller that is used to control operation of the powertrain. According to the method, the controller can receive a shift signal that directs a gear shift in the transmission, which includes a plurality of selectively engageable gear ratios. The shift signal can signify either an upshift or a downshift. The controller monitors the transmission during the gear shift for a torque phase during which the speed ratio of the transmission remains relatively constant and for an inertia phase during which the speed ratio of the transmission changes. During the torque phase, the controller maintains a pre-existing fluid pressure in a lockup clutch that is associated with a torque convertor disposed between the engine and the transmission. However, during the inertia phase, the controller reduces the pre-existing fluid pressure in the lockup clutch so that the lockup clutch slips and rotational power is transferred at least in part through the torque convertor.

### BRIEF DESCRIPTION OF THE DRAWINGS

FIG. 1 is a side elevational view of a mobile machine such as a dozer having a powertrain that transfers a motive force from a prime mover power source to propulsion devices and/or work implements.

FIG. 2 is a schematic illustration of the powertrain of the machine including a multispeed transmission connected to a power source such as an internal combustion engine by way of a torque convertor having an associated lockup clutch.

FIG. 3 is a chart including a series of graphs illustrating the possible relationship between transmission speed ratio, transmission clutch pressure, and lockup clutch pressure during an upshift in gear ratios of the powertrain.

FIG. 4 is a chart including a series of graphs illustrating the possible relationship between transmission speed ratio, transmission clutch pressure, and lockup clutch pressure during a downshift in gear ratios of the powertrain.

FIG. 5 is a chart including a series of graphs illustrating the possible relationship between transmission speed ratio, transmission clutch pressure, and lockup clutch pressure for a direction change in the powertrain.

FIG. 6 is a block diagram flowchart depicting a control strategy and method for regulating the lockup clutch in coordination with the transmission when shifting gear ratios.

### DETAILED DESCRIPTION

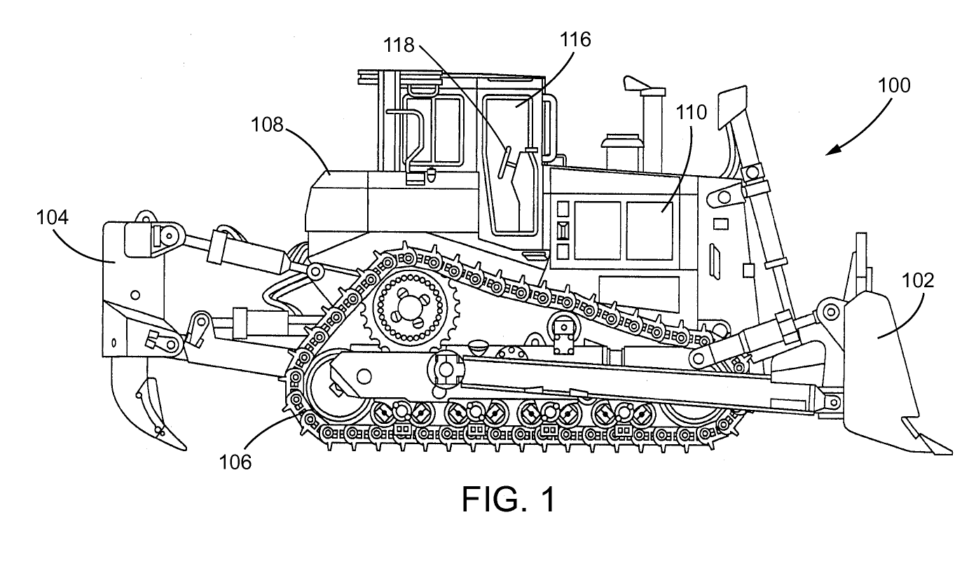

This disclosure relates generally to a machine having a powertrain including a multispeed transmission and, more particularly, to powertrains that include automatic transmissions and torque converters capable of directly and selectively coupling the output of a power source with the transmission at any gear setting of the transmission. Now referring to FIG. 1, wherein like reference numbers refer to like elements, there is illustrated an embodiment of a machine 100 and, in particular, a dozer designed in accordance with the present disclosure. However, the disclosure is applicable to other types of machines in addition to dozers and, as used herein, the term “machine” may refer to any type of machine that performs some operation associated with an industry such as mining, construction, farming, transportation, or any other industry known in the art. Examples of such machines include but are not limited to wheel loaders, bulldozers, excavators, back hoes, compactors, pavers, etc. Moreover, an implement may be connected to the machine. Such implements can be utilized for a variety of tasks, including, for example, loading, dozing, compacting, lifting, brushing, and include, for example, buckets, compactors, fork lifting devices, brushes, grapples, cutters, shears, blades, breakers/hammers, augers, and others. Additionally, the machine can be used in the transportation field such as on-highway trucks, cargo vans, or the like.

The machine 100 and specifically the dozer shown in FIG. 1 can include work implements such as a ground-engaging implement like a blade 102 that can be used for displacing earth or another material across the surface of a worksite. The blade 102 may be hydraulically powered to lift or lower with respect to the surface of the worksite. Another work implement associated with the machine can be a claw-like ripper 104 used for breaking up hard ground or pavement which can also be hydraulically moved with respect to the surface of the worksite. To propel the machine 100 with respect to the worksite surface, the machine can include one or more propulsion devices 106 such as, for example, a pair of continuous tracks as illustrated in FIG. 1 that are driven by an appropriate drive sprocket 107 or the like. However, in other embodiments of the disclosure, other traction devices such as wheels, belts, and the like may be included as part of the machine. The work implements including the blade 102 and ripper 104 can be supported by the frame or chassis 108 of the machine 100 that can be supported on the propulsion devices 106.

To power operation of the machine 100 including the propulsion devices 106, a power source sometimes referred to as a prime mover can be incorporated on the chassis 108. A suitable example of a power source shown in FIG. 1 is an internal combustion engine 110 such as a compression ignition diesel engine that burns a hydrocarbon based fuel to convert the potential or chemical energy therein to mechanical power that maybe used for other work. However, in other embodiments, other suitable types of power sources can include spark-ignition gasoline engines, turbines, hybrid engines, solar powered engines, and the like. To direct operation of the machine 100, an operator station 116 configured to accommodate an operator can be disposed on the chassis. The operator station 116 can house various controls and/or inputs such as an accelerator for controlling the engine 110 and/or steering devices 118 for steering the propulsion devices 106. In a possible embodiment, however, the machine 100 can be configured for remote operation with the controls located remotely from the machine.

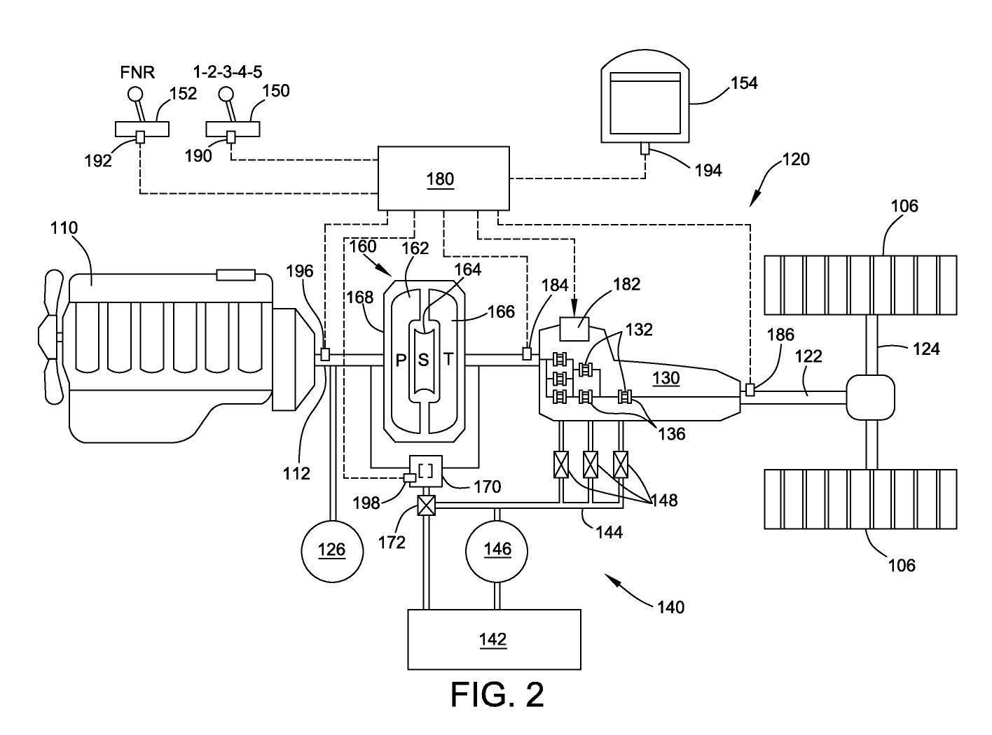

To transfer the mechanical or motive power produced by the engine 110, which is typically embodied as rotational motion applied to a crankshaft of the engine, to the propulsion devices 106, the engine can be operatively associated with a powertrain 120. As will be recognized by those of skill in the art, powertrains include various components such as shafts, clutches, differentials and the like for transmitting and/or manipulating the generated forces through the machine. For example, referring to FIG. 2, there is illustrated an exemplary embodiment of a powertrain 120 that may be included on the machine connecting the engine 110 to the propulsion devices 106. Specifically, the engine 110 outputs rotational power at the crankshaft 112 that is transferred through the powertrain 120 to rotate a driveshaft 122 and/or one or more axles 124 to drive the one or more propulsion devices 106 in a synchronous or non-synchronous manner. In addition, one or more power takeoffs 126 can be operatively associated with the powertrain 120 to redirect a portion of the power generated by the engine 110 to the work implements.

As is known to those of skill in the art, the speed and torque output of an internal combustion engine is determined by the amount and rate at which fuel is combusted, which in turn may be constrained by the physical limitations of the engine. For example, for a diesel-burning internal combustion engine, the maximum speed may be 2000 RPM and the minimum may be 800 RPM which may require reduction to propel the propulsion devices at a reasonable speed. Furthermore, engines typically rotate the crankshaft in one direction that could place a corresponding limitation on the movement of the propulsion devices. Accordingly, to adjust the speed and torque output and the rotational direction of the engine 110, the powertrain can include a transmission 130 disposed between the engine and the propulsion devices. By way of example, the transmission 130 can be a multispeed transmission that includes a plurality of selectively engageable friction elements which, in the illustrated embodiment, can be a series of interacting gears 132. The plurality of gears 132 can be arranged in predetermined pairs or groups so that when engaged, the transmission 130 produces a specific gear ratio that is dependent upon the size and number of teeth of the selected gears. The gear ratio is directly related to the speed ratio of the transmission which defines the increase or decrease in rotational speed between the transmission input shaft 134 and the driveshaft 122 that may be associated with the transmission output. Because the speed ratio is typically calculated as input speed/output speed, at least with respect to machine speed, the speed ratio has an inverse relation to the machine speed, with an decrease in speed ratio corresponding to an increase in machine speed and an increase in speed ratio corresponding to a decrease in machine speed. The gear ratio or speed ratio can also define, in an inverse relationship, the change in output torque caused by the transmission. The transmission can include any suitable number of predefined, selectable gear ratios. Further, the transmission 130 can also include a gear combination that reverses the rotational direction of the crankshaft 112 input from the engine 110. The selective change between engaged gear ratios is sometimes referred to as shifting gears, with upshifting referring to a decrease in speed ratio and downshifting referring to an increase in speed ratio.

In an embodiment, the transmission 130 can be a synchronous transmission wherein the gear combinations that make up the predetermined gear ratios are continuously meshed together and one or more clutches are used to bring selected gear ratios into and out of fixed engagement with rotating shafts in the transmission that couple the crankshaft 112 and the driveshaft 122. Accordingly, in the illustrated embodiment, the plurality of gears 132 that make up the gear ratios can be operatively associated with a plurality of clutches 136. The plurality of clutches 136 can be hydraulic clutches that are engaged or released by controlling pressure of a hydraulic fluid supplied to the respective clutch, although in other embodiments the clutches may be activated by other technologies such as electromagnetic forces. When shifting up or down gear ratios, one set of clutches is pressurized to engage an unengaged gear ratio while a second set of clutches is simultaneously depressurized to disengage an engaged ratio. The first set may be referred to as the on-coming clutches and the second set may be referred to as the off-going clutches.

To supply hydraulic fluid to the plurality of clutches 136 in the illustrated embodiment, the powertrain 120 can be operatively associated with a hydraulic system 140 that includes a tank or refillable reservoir 142 for containing the hydraulic fluid and a plurality of interconnecting pipes or conduits 144 for fluid communication of the hydraulic fluid to and from the transmission 130. To pressurize and direct the hydraulic fluid in the hydraulic system, a hydraulic pump 146 can also be disposed in communication with the reservoir 142 and conduits 144. To control the actual flow of hydraulic fluid to and from the plurality of clutches 136 and relatedly the fluid pressure in the clutches, one or more flow-control pressure regulator valves 148 such as spool valves, shuttle valves, and the like, can be disposed in the conduits 144 of the hydraulic system 140.

To enable operator control of the transmission 130, the machine 100 can include one or more control inputs. For example, in an embodiment, the transmission 130 can be a manual transmission in which the operator selectively engages specific gear ratios, i.e., upshifts or downshifts, by manipulating a gear selector 150 such as a gear stick. However, in other embodiments, the transmission 130 may be an automatic transmission in which most of the engageable gear ratios are selected without direct operator intervention and in which case the gear selector 150 can be eliminated. The inputs can also include a forward-neutral-reverse (F-N-R) selector 152 that can decouple the engine 110 from the powertrain 120 to place the machine 100 in neutral and/or direct the transmission 130 to engage the specific gear ratios that reverse the rotational output of the engine. Although in the illustrated embodiment the gear selector 150 and F-N-R selector 152 are illustrated as levers, in other embodiments they can be other suitable controls such as buttons. In addition, the machine 100 can include an operator display panel 154 such as a LCD screen or the like to display information about the machine to the operator. The gear selector 150, F-N-R selector 152, and the operator display panel 154 can be disposed in the operator station 116 with the other inputs for controlling the machine 100 such as the steering mechanism and accelerator. However, in those embodiments in which the machine is controlled remotely, the gear selector 150, F-N-R selector 152, and the operator display panel 154 can likewise be located off the machine.

To facilitate shifting gear ratios and/or acceleration of the machine 100, the powertrain 120 can include a torque convertor 160 disposed between the engine 110 and the transmission 130. The torque convertor 160 can be a hydraulic device that decouples the engine 110 from direct mechanical connection with the transmission. In an embodiment, the torque convertor 160 can include an impeller 162, a stator 164, and a turbine 166 disposed within a sealed housing 168 that can be filled with hydraulic fluid from the hydraulic system 140. The impeller 162 and the turbine 166 can be arranged in an opposing relationship and the stator 164 disposed between them. Moreover, the impeller 162 can be directly or indirectly coupled to and rotatable with the crankshaft 112 and the turbine 166 can be directly or indirectly coupled to and rotatable with the transmission input shaft 134. Rotating the impeller 162 within the housing 168 by corresponding rotation of the engine 110 causes the hydraulic fluid therein to circulate in a manner that can drive the turbine 166 in the same direction thus spinning the driveshaft 122. The torque convertor converts kinetic mechanical energy from the engine to dynamic fluid power and back to mechanical energy. Thus, the torque convertor 160 functions as a fluid coupling that can enable the crankshaft 112 and the transmission input shaft 134 to rotate at different speeds and, in some instances, can effectively decouple the engine 110 from the propulsion devices 106 when the machine 100 is stationary. Moreover, the stator 164 can include nozzles or fins that facilitate circulation of the hydraulic fluid in a manner that increases the torque transfer through the torque convertor to assist acceleration or handling of significant loads.

Because the indirect fluid coupling provided by the torque convertor 160 allows for slip between the crankshaft 112 and the transmission input shaft 134, the torque convertor almost always results in some loss between input power and output power thereby lowering efficiency of the powertrain 120. To reduce this power loss, especially when the rotational input and output can be maintained at the same rotational speed, the torque convertor 160 can be operatively associated with a lockup clutch 170 that physically locks the crankshaft 112 and transmission input shaft 134 in a direct mechanical coupling. The lockup clutch 170 can be a pressure activated, hydraulic device that is in fluid communication with the hydraulic system 140. To control the fluid pressure to and from the lockup clutch 170 for selective engagement and/or disengagement, a lockup valve 172 can be disposed in the hydraulic system 140 between the hydraulic pump 146 and the lockup clutch. When engaged, the lockup clutch 170 bypasses the fluid coupling provided by the torque convertor 160 and avoids slipping losses that occur between the impeller 162 and the turbine 166. In an embodiment, the lockup clutch can be dog clutch or similar device for eliminating slip.

To coordinate and control the various components in the powertrain 120, the machine 100 may include an electronic or computerized control unit, module or controller 180. The controller 180 may be adapted to monitor various operating parameters and to responsively regulate various variables and functions affecting the powertrain. The controller 180 may include a microprocessor, an application specific integrated circuit (ASIC), or other appropriate circuitry and may have memory or other data storage capabilities.

The controller can include functions, steps, routines, control maps, data tables, charts and the like saved in and executable from read-only memory or another electronically accessible storage medium to control the engine system. Storage or computer readable mediums may take the form of any media that provides instructions to the controller for execution. The mediums may take the form of non-volatile media, volatile media, and transmission media. Non-volatile media includes, for example, optical or magnetic disks. Volatile media includes dynamic memory. Transmission media includes coaxial cables, copper wire and fiber optics, and may also take the form of acoustic or light waves, such as those generated during radio-wave and infra-red data communications. Common forms of computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave or any other medium from which a computer or processor may read.

Although in FIG. 2, the controller 180 is illustrated as a single, discrete unit, in other embodiments, the controller and its functions may be distributed among a plurality of distinct and separate components. To receive operating parameters and send control commands or instructions, the controller may be operatively associated with and may communicate with various sensors and controls in the operator station 116 and associated with the various components in the powertrain 120. Communication between the controller and the sensors and controls may be established by sending and receiving digital or analog signals across electronic communication lines or communication busses. The various communication and command channels are indicated in dashed lines for illustration purposes.

For example, to control the settings of the transmission 130, including sending commands to engage specific gear ratios, the controller 180 can communicate with a transmission control 182 operatively associated with the transmission. In addition, to assess other operational characteristics of the transmission 130, the controller 180 can communicate with a transmission input shaft sensor 184 measuring the rotational speed of the transmission input shaft 134 and a driveshaft sensor 186 measuring the rotational speed of the driveshaft 122. Measurement signals from these sensors, which may be magnetic pickup sensors or the like, can be communicated to the controller 180 that can perform the appropriate calculations to determine the actual speed ratio being produced. To enable operator adjustment of the transmission settings, the controller 180 can communicate with a gear selector sensor 190 and a direction selector sensor 192 associated with the respective gear selector 150 and direction selector 152 disposed in the operator station 116. The controller can also communicate with the operator display panel 154 via a display control 194 to interface with the operator. Command signals received from those controls can be processed by the controller and transmitted to the transmission control 182 to adjust the transmission settings accordingly.

To control and monitor the torque convertor 160, the controller 180 can communicate with a crankshaft sensor 196 that senses the rotational speed of the crankshaft 112. Due to the direct coupling of the respective components, information from the crankshaft sensor 196 can reflect the rotational speed of the impeller 162 while information from the transmission input shaft sensor 184 associated with the transmission input shaft 134 can reflect the speed of the turbine 166. The controller 180 can therefore determine the relative speed of the impeller 162 and the turbine 166 and thus the slip and efficiency losses in the torque convertor 160. In addition, the controller 180 can send and receive signals with a lockup clutch control 198 operatively associated with the lockup clutch 170 and/or lockup valve 172. The lockup clutch control 198 can change the fluid pressure to engage or disengage the lockup clutch 170 at appropriate times to bypass the torque convertor 160.

In an embodiment, the controller 180 can be configured to facilitate shifting of gear ratios in the transmission 130 by responsive adjustment of the torque convertor 160 and the lockup clutch 170. For example, changing a first gear ratio to a second gear ratio, especially when those gear ratios are associated with large differences in speed ratios, can transmit speed, power, or torque surges through the powertrain 120 jolting the machine. However, the controller 180 can monitor and process information signals received from the transmission control 182, transmission input shaft sensor 184, and the driveshaft sensor 186 associated with the transmission 130 to responsively regulate fluid pressure and thus engagement of the lockup clutch 170 so that speed, power, and torque surges can be dissipated in the torque convertor 160. Further, controlled regulation of the lockup clutch and torque convertor can be adapted for different types of gear shifts such as upshifting and downshifting.

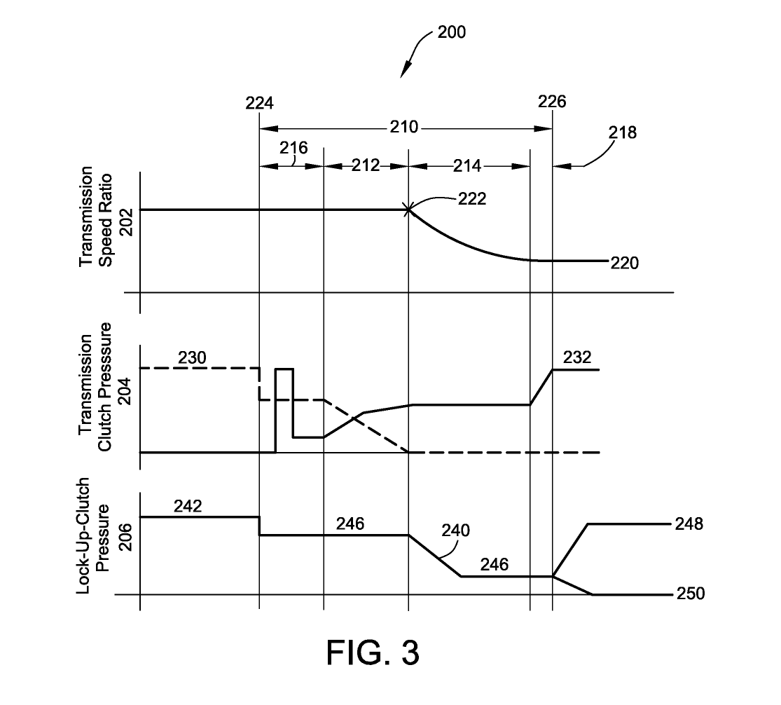

For example, referring to FIG. 3, there is illustrated three graphs including a transmission speed ratio graph 202, a transmission clutch pressure graph 204, and a lockup clutch pressure graph 206, depicting the operational parameters of the powertrain during a gear shift, in particular, an upshift 200 of gear ratio in the transmission according to the disclosure. Referring to the transmission speed ratio graph 202, it can be seen that the duration of the gear shift process 210 represented by the labeled arrow between a shift start point 224 and a shift complete point 226 can occur in two or more phases including a torque phase 212 and an inertia phase 214, also represented by respective arrows. In fact, the gear shift process 210 can include additional phases including a fill phase 216 and a max phase 218 that can generally be ignored for present purposes. During the torque phase 212, the speed ratio of the transmission represented by the speed ratio curve 220 remains at the pre-shift value associated with the off-going, i.e., disengaging, clutches. During the inertia phase 214, though, the speed ratio curve 220 begins to transition to the speed ratio value associated with the oncoming clutches. The transition between the torque phase 212 and the inertia phase 214 can be represented by a phase transition point 222 on the speed ratio curve 220 that corresponds to the start of an increase in output speed of the transmission during an upshift 200.

The shape of the speed ratio curve 220 reflects the parameters depicted in the transmission clutch pressure graph 204. In particular, the flat slope of the speed ratio curve 220 corresponds to decreasing fluid pressure in the off-going clutches 230 being released, represented by a dashed line, while the decreasing slope of the speed ratio curve corresponds to increasing fluid pressure in the oncoming clutches 232 being engaged, represented by the solid line. During the torque phase 212, the oncoming clutches 232 are not sufficiently engaged and the speed ratio of the transmission remains synchronized to the off-going clutches. The phase transition point 222 of the speed ratio curve 220 can correspond to the moment when the off-going clutches 230 begins to slip and the speed ratio of the transmission synchronizes with the speed ratio associated with the oncoming clutches 232. The controller can determine the shift from the torque phase 212 to the inertia phase 214, and thus determine the release of the off-going clutches 230 and engagement of the oncoming clutches 232, by monitoring for the phase transition point 222 on the speed ratio curve 220.

The controller can utilize the information obtained to regulate fluid pressure in the lockup clutch as indicated by the lockup clutch pressure curve 240 in the lockup clutch pressure graph 206. For example, the lockup clutch pressure curve 240 can be maintained at a locked pressure 242 prior to the shift start point 224 so that fluid pressure in the lockup clutch is sufficiently high that the crankshaft and transmission input shaft are mechanically locked together. At the shift start point 224, the excess fluid pressure in the lockup clutch can be decreased to an unlocked pressure 244 where the lockup clutch continues to avoid slipping and power transfer continues primarily through the lockup clutch. Further, at the unlocked pressure, the clutch may have a capacity approximating the clutch capacity anywhere at or above the point of being physically locked. In an embodiment, the controller may recognize the shift start point 224 and reduce fluid pressure to the unlocked condition in response to receiving a shift signal from the gear selector. At the unlocked pressure 244, the lockup clutch is set to promptly respond to the onset of the inertia phase 214. At the onset of the inertia phase 214 corresponding to the phase transition point 222, the fluid pressure of the lockup clutch is further reduced to a hold pressure 246 wherein the lockup clutch remains filled with hydraulic fluid but experiences significant slip. Further, at the hold pressure, the clutch may be at or near the minimal capacity in preparation for the next desired state of the clutch, which may be returning to the engaged state, completely disengaging, or some other suitable state. With the lockup clutch slipping, a portion of the power transfer through the powertrain, including any speed, power, or torque surges, can be redirected through the torque convertor.

At the conclusion of the gear shift process 210 signified by the shift complete point 226, the lockup clutch can be mechanically reengaged by increasing the fluid pressure to the locked pressure 242 as indicated by the reengagement curve 248. Power transfer thereafter through the powertrain primarily occurs through the direct mechanical connection of the lockup clutch. In other embodiments, the lockup clutch can be fully disengaged by reducing the fluid pressure to a point where the lockup clutch is substantially empty of hydraulic fluid as indicated by the disengagement curve 250. At this point, substantially all transfer of rotational power in the powertrain is through the torque convertor. The determination to disengage the lockup clutch can be based on the desirability of utilizing the torque convertor to accommodate the operating conditions of the machine, such as whether the machine is stationary or undergoing acceleration.

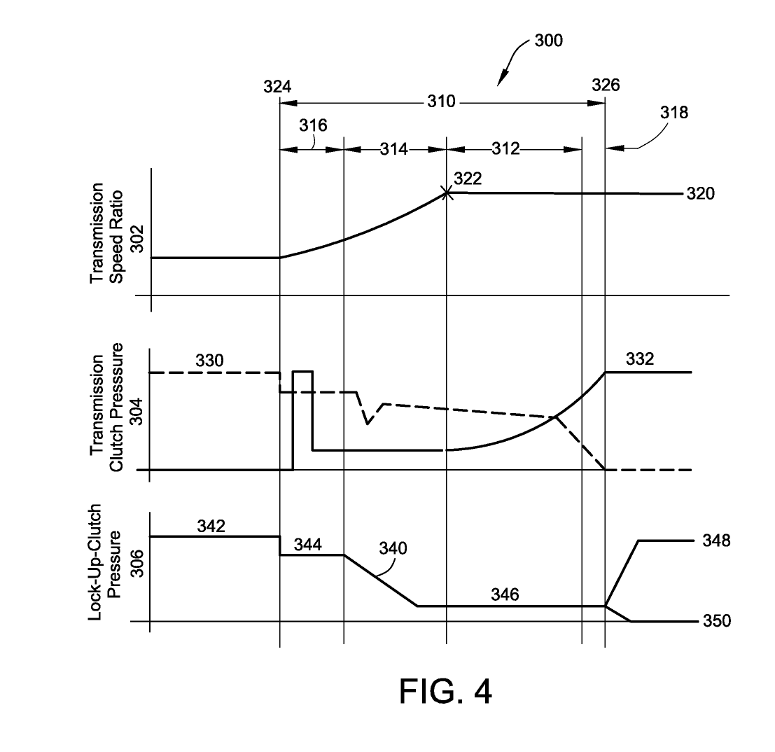

In a further embodiment, the controller can monitor the transmission parameters to facilitate downshifting of gear ratios. Referring to FIG. 4, there are illustrated three graphs including a transmission speed ratio graph 302, a transmission clutch pressure graph 304, and a lockup clutch pressure graph 306. The graphs depict the operational parameters of the powertrain during a gear shift 310 corresponding to a downshift in gear ratios occurring between a shift start point 324 and a shift end point 326. As seen in the transmission speed ratio graph 302, during a downshift 300, the inertia phase 314 occurs prior to the torque phase 312. Accordingly, at commencement of the inertia phase 314 soon after the shift start point 324 the speed ratio curve 320 increases reflecting a corresponding change from the speed ratio associated with the off-going clutches. When the gear shift 310 transitions to the torque phase 312 at the phase transition point 322, the transmission output corresponds to the speed ratio associated with the oncoming clutches and the speed ratio curve 320 flattens.

The shape of the speed ratio curve 320 reflects the occurrences depicted in the transmission clutch pressure graph 304. When the fluid pressure in the off-going clutches 330, indicated in dashed lines, decreases shortly after the shift start point 324 and the off-going clutches begins to release, the weight of the machine quickly causes the off-going clutches to slip resulting in the corresponding increase of the speed ratio curve 320. By the time the oncoming clutches 332 fills with hydraulic fluid and begins to engage, the speed ratio of the transmission has synchronized with the speed ratio of the oncoming clutches and the speed ratio curve 320 flattens. The controller again can determine the transition between the inertia phase 314 and the torque phase 312 by monitoring the speed ratio curve 320 for the phase transition point 322.

The controller responsively regulates fluid pressure in the lockup clutch based on the observed parameters of the speed ratio curve 320. In particular, referring to the lockup clutch pressure graph 306, the lockup clutch pressure curve 340 can be reduced from a locked pressure 342 prior to the shift start point 324 to a unlocked pressure 344 where the lockup clutch is unlocked but does not slip significantly after the shift start point. Further, at the unlocked pressure, the clutch may have a capacity approximating a clutch capacity anywhere at or above the point of being physically locked. Because the inertia phase 314 occurs soon afterwards and the speed ratio curve 320 soon rises, the controller can reduce the lockup clutch pressure curve 340 to the hold pressure 346 wherein the lockup clutch begins to slip. Further, at the hold pressure, the clutch may be at or near the minimal capacity in preparation for the next desired state of the clutch, which may be returning to the engaged state, completely disengaging, or some other suitable state. Accordingly, during the increase in speed ratio curve 320 associated with the inertia phase 314, the powertrain transmits at least a portion of the rotational power including any speed, power, or torque surges through the torque convertor. At the conclusion of the gear shift 310, the lockup clutch can be reengaged as indicated by the reengagement curve 348 or completely disengaged as indicated by the disengagement curve 350.

As can be seen by comparing FIGS. 3 and 4, during both upshifting 200 and downshifting fluid pressure in the lockup clutch is maintained during the torque phase and only reduced during the inertia phase. Moreover, because fluid pressure of the lockup clutch is reduced to the hold pressure only upon a change in the absolute value of the speed ratio, regardless of whether the change is an increase or a decrease, regulation of the lockup clutch occurs independent of the order of the torque and inertia phases. Accordingly, the controller can regulate the lockup clutch without knowing whether the gear shift is specifically an upshift 200 or downshift 300.

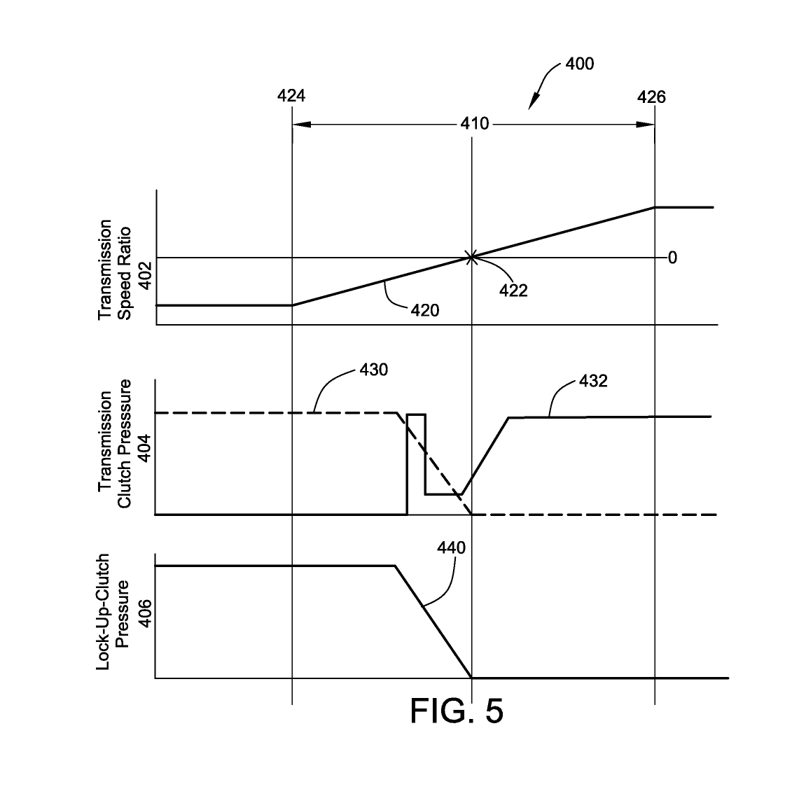

In addition to the graphs representing an upshift 200 and downshift 300 depicted in FIGS. 3 and 4, the controller can also be adapted to responsively regulate a direction shift. For example, referring to FIG. 5, where the transmission performs a direction shift 400 as indicated in the transmission speed ratio graph 402 at the shift start point 424, the speed ratio curve 420 will rise to zero corresponding to the transition point 422. The speed ratio curve 420 will then continue in the opposite direction as would correspond to shifting the machine from forward to neutral to reverse. Referring to the transmission clutch pressure graph 404, the speed ratio curve 420 reflects release of the off-going clutches 430 associated with one direction and engagement of the oncoming clutches 432 associated with the opposite direction by relieving and applying fluid pressure to the clutches in an appropriate manner. Referring to the lockup clutch pressure graph 406, since in this scenario it is desirable to completely disengage the lockup clutch prior to reversing the transmission, the lockup clutch pressure curve 440 can be reduced simultaneously with the fluid pressure of the off-going clutches 430. Accordingly, power transfer through the powertrain can occur exclusively through the torque convertor at the approximate commencement of the transition point 422.

### INDUSTRIAL APPLICABILITY

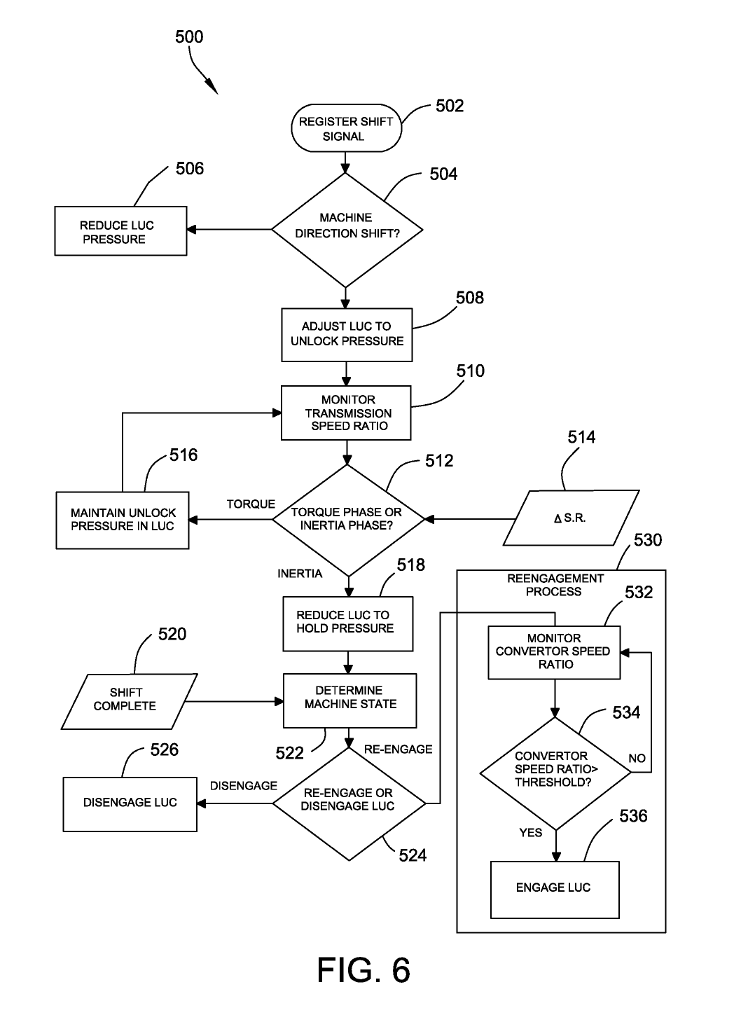

In accordance with an aspect of the disclosure, a controller can regulate a torque convertor and an associated lockup clutch to accommodate different types of gear shifts in a transmission having a plurality of selectable gear ratios to reduce surges or jolts due to the gear shift. Referring to FIG. 6, there is illustrated an embodiment of a flowchart 500 for conducting the described regulation of the powertrain components. The steps and actions described by the flowchart 500 may be set forth in computer-readable instructions accessible by and executable in the controller.

In an initial registration step 502, the controller can receive and register a shift signal indicating initiation of a gear shift. The shift signal may result from automatic operation of an automatic transmission or result from an operator handling a gear stick. To account for a shift in the travel direction of the machine, the controller performs a direction query step 504 to assess if the shift signal is indicative of direction shift. If yes, the controller performs a first pressure reduction step 506 in which the fluid pressure of the lockup clutch (LUC) is reduced to disengage the lockup clutch. The first pressure reduction step 506 may be timed to occur simultaneously with reduction of fluid pressure in the off-going clutches so that any speed, power, or torque surges resulting from reconfiguring the transmission gear ratios are directed to the torque convertor. The hydraulic coupling in the torque convertor can dampen or dissipate the speed, power, or torque surge. If the result of the direction query step 504 is no, the controller can perform a first pressure adjustment step 508 to adjust the fluid pressure in the lockup clutch to an unlocked pressure. The unlocked pressure relieves any excess fluid pressure so that the lockup clutch remains at a point just above slipping and is set to promptly disengage.

Once the lockup clutch is at the unlocked pressure, the controller monitors the speed ratio of the transmission in a monitor speed ratio step 510. Monitoring the speed ratio enables the controller to determine, in a phase determination step 512, the particular phase the gear shift is in. The torque phase can correspond to a relatively constant speed ratio and the inertia phase can correspond to an increase or decrease in speed ratio. In an embodiment, the controller can be programmed to query for a degree or percentage in change of the speed ratio (i.e. ΔS.R. 514) to accommodate speed fluctuations in the powertrain. If there is no substantial change in the speed ratio or the speed ratio changes remain within ΔS.R. 514 and the phase determination step 512 concludes the gear shift is in the torque phase, the controller maintains the current fluid pressure in the lockup clutch in a maintain pre-existing pressure step 516. If the speed ratio does change and the phase determination step 512 concludes that the gear shift is in the inertia phase, the controller can perform a second pressure reduction step 518 wherein the pre-existing fluid pressure in the lockup clutch is reduced to a hold pressure. At the hold pressure, the lockup clutch is partially filled with hydraulic fluid but undergoes significant slip. Accordingly, at least a portion of any speed, power, or torque surges are directed through the torque convertor and dampened. Further, at the hold pressure, the clutch may be at or near the minimal capacity in preparation for the next desired state of the clutch, which may be returning to the engaged state, completely disengaging, or some other suitable state. Thus result of the phase determination stage is that fluid pressure in the lockup clutch is maintained during the torque phase and only reduced during the inertia phase regardless of their order of occurrence. In an embodiment, the ΔS.R. 514 can be set to provide a slight delay between commencement of the inertia phase and reduction of fluid pressure in the lockup clutch.

Once the gear shift is complete, which can be signified by a shift complete signal 520 received by the controller, the controller can determine whether to disengage or reengage the lockup clutch. To accomplish this, the controller in a machine state determination step 522 determines the operating conditions such as whether the machine is in neutral or under load. If the controller determines such conditions exist during a re-engagement/disengagement determination step 524, the controller can implement a disengagement step 526 in which the lockup clutch is disengaged or maintained in a disengaged state. The engine is thus decoupled from the rest of the powertrain and engine output can be dissipated in the torque convertor. If the re-engagement/disengagement determination step 524 determines to reengage the lockup clutch, for instance, if the machine is operating steadily at the newly selected gear ratio, the controller in an embodiment can institute a reengagement process 530. In the reengagement process 530, the controller in a monitor torque convertor step 532 monitors the speed ratio of the torque convertor, i.e., the difference in rotational speed between the impeller and the turbine, which is thus distinguished from the speed ratio associated with the transmission. The torque convertor speed ratio is compared to a threshold value, for example, 90% of unity, in a reengagement determination step 534 to decide if conditions are appropriate to reengage the lockup clutch. If the torque convertor speed ratio is below the threshold value, the lockup clutch continues to slip and the controller continues to monitor the torque convertor speed ratio. If the torque convertor speed ratio is above the threshold, the controller in an engagement step 536 reengages the lockup clutch.

A possible advantage of the foregoing process is it can accommodate various types of gear shifts including upshifting and downshifting. In particular, because the monitor speed ratio step 510 continuously monitors the speed ratio of the transmission, the control process can be timed and particularized to the torque phase and the inertia phase independent of the order they occur. The same absolute change in speed ratio, regardless of whether it is an increase or decrease, will trigger adjustment of the lockup clutch. In other words, by monitoring for speed ratio change signifying the phrase transition point during the gear shift, the control strategy indirectly determines and accounts for both upshifting and downshifting gear ratios.

A possible related advantage is that the process works well with both automatic transmissions and manual transmissions wherein gear shifts can occur unexpectedly. Because the process is independent of the actual gear ratios engaged and is initiated by the same condition, a change in the absolute speed ratio, the process simplifies communication between the controller and gear selector. In other words, information about the gear shift does not need to be specific to the gear ratios involved or the direction of the gear shift.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context.

Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

We claim:

1. A method of shifting gear ratios in a machine with a powertrain including an engine connected to a transmission through a torque convertor, the transmission including a plurality of gear ratios that are selectively engageable for changing a speed ratio of the transmission, the method comprising:
receiving a shift signal directing a gear shift in the transmission;
adjusting fluid pressure in a lockup clutch associated with the torque convertor to an unlocked pressure at which the lockup clutch is unlocked but does not experience significant slip;
monitoring the speed ratio of the transmission for an inertia phase of the gear shift during which the speed ratio changes and for a torque phase of the gear shift during which the speed ratio remains relatively constant; and
upon commencement of the inertia phase, reducing fluid pressure of the lockup clutch to a hold pressure during which the lockup clutch experiences significant slip.

2. The method of claim 1, wherein the step of monitoring the speed ratio further includes determining a change in the speed ratio from a speed ratio value prior to receiving the shift signal.

3. The method of claim 1, wherein the gear shift is an upshift associated with a decrease in the speed ratio and wherein the torque phase occurs before the inertia phase.

4. The method of claim 3, further comprising maintaining the unlocked pressure during the torque phase.

5. The method of claim 1, wherein the gear shift is a downshift associated with an increase in the speed ratio and the inertia phase occurs before the torque phase.

6. The method of claim 5, further comprising maintaining the hold pressure during the torque phase.

7. The method of claim 1, further comprising determining whether the gear shift is complete and increasing fluid pressure in the lockup clutch to a locked pressure to engage the lockup clutch.

8. The method of claim 7, wherein the step of increasing fluid pressure in the lockup clutch further comprises:
monitoring a torque convertor speed ratio of the torque convertor;
maintaining the lockup clutch at the hold pressure if the torque convertor speed ratio is below a threshold value; and
setting the lockup clutch to the locked pressure if the torque convertor speed ratio is above the threshold value.

9. The method of claim 1, further comprising determining whether the gear shift is complete and setting the lockup clutch to a disengaged state.

10. The method of claim 1, further comprising determining if the shift signal is indicative of a direction shift of the machine and setting the lockup clutch to a disengaged state.

11. The method of claim 1, wherein the transmission includes a plurality of clutches, each clutch operatively associated with a gear of the transmission.

12. The method of claim 1, wherein the gear shift is accomplished by increasing fluid pressure of a oncoming clutches to engage an oncoming gear and decreasing fluid pressure of an off-going clutches to engage an off-going gear.

13. A machine comprising:
an engine for generating a rotational force;
a transmission connected to the engine, the transmission including a plurality of gear ratios that are selectively engageable for changing a speed ratio of the transmission;
an gear selector for directing a gear shift of the plurality of gear ratios;
a sensor operatively associated with the transmission to monitor the speed ratio;
a torque convertor operatively disposed between the engine and the transmission, the torque convertor associated with a lockup clutch; and
a controller communicating with the gear selector and the sensor, the controller further reducing fluid pressure the lockup clutch during an inertia phase of the gear shift when the speed ratio changes and maintaining fluid pressure in the lockup clutch during a torque phase when the speed ratio is relatively constant.

14. The machine of claim 13, wherein the controller adjusts fluid pressure in the lockup clutch to an unlocked pressure during which the lockup clutch is unlocked but does not experience significant slip upon receiving a shift signal indicative of the gear shift from the gear selector.

15. The machine of claim 14, wherein the gear shift is an upshift associated with an increase in the speed ratio and wherein the torque phase occurs before the inertia phase.

16. The machine of claim 14, wherein the gear shift is a downshift associated with a decrease in the speed ratio and the inertia phase occurs before the torque phase.

17. The machine of claim 13, wherein the controller reduces fluid pressure in the lockup clutch to a hold pressure during which the lockup clutch experiences significant slip.

18. A method of operating a machine having a powertrain including an engine directing rotational power to a transmission, the powertrain under control of a controller, the method comprising:
receiving a shift signal commanding a gear shift in the transmission including a plurality of gear ratios that are selectively engageable, the gear shift being one of an upshift or a downshift;
monitoring the transmission during the gear shift for a torque phase during which a speed ratio of the transmission remains relatively constant and for an inertia phase during which the speed ratio of the transmission changes;
maintaining a pre-existing fluid pressure in a lockup clutch associated with a torque convertor disposed between the engine and the transmission during the torque phase; and
reducing the pre-existing fluid pressure in the lockup clutch during the inertia phase so that the lockup clutch slips and rotational power is transferred at least in part through the torque convertor.

19. The machine of claim 18, wherein the upshift is associated with an increase in the speed ratio and wherein the torque phase occurs before the inertia phase.

20. The machine of claim 18, wherein the downshift is associated with a decrease in the speed ratio and the inertia phase occurs before the torque phase.
